(19) United States
(12) Patent Application Publication
(10) Pub. No.: US 2012/0259044 A1
(43) Pub. Date: Oct. 11, 2012

(54) HYPERBRANCHED POLYMERS FOR MODIFYING THE TOUGHNESS OF ANIONICALLY CURED EPOXY RESIN SYSTEMS

(75) Inventors: Michael HENNINGSEN, Frankenthal (DE); Jean-Francois Stumbe, Strasbourg (FR); Anna Cristadoro, Heppenheim (DE); Volker Alstaedt, Bayreuth (DE); Manfred Doering, Woerth (DE); Lin Zang, Karlsruhe (DE); Alexander Schmidt, Essen (DE); Johannes Kraemer, Speichersdorf (DE)

(73) Assignee: BASF SE, Ludwigshafen (DE)

(21) Appl. No.: 13/440,463

(22) Filed: Apr. 5, 2012

Related U.S. Application Data
(60) Provisional application No. 61/473,199, filed on Apr. 8, 2011.

(51) Int. Cl. C08L 63/02; C08L 67/00

(52) U.S. Cl. 523/466; 525/418; 523/468

(57) ABSTRACT

The invention relates to a curable composition comprising one or more epoxy compounds, one or more anionically curing catalysts, and an addition of one or more dendritic polymers, selected from the group consisting of the dendritic polyester polymers, the dendritic polyesteramide polymers, and the dendritic polymers based on 1,3,5-tris-alkanol-substituted cyanuric acid. These dendritic polymers improve mechanical properties, in particular the toughness of the cured epoxy resin.

The present application incorporates by way of reference the current U.S. application No. 61/473,199 filed on Apr. 8, 2011.

The invention relates to a curable composition comprising one or more epoxy compounds, one or more anionically curing catalysts and an addition of one or more dendritic polymers, selected from the group consisting of the dendritic polyester polymers, the dendritic polyesteramide polymers, and the dendritic polymers based on 1,3,5-tris-alkanol-substituted cyanuric acid.

The invention further relates to the process for producing cured epoxy resins from the curable composition, and also the use of dendritic polymers selected from the group consisting of the dendritic polyester polymers, the dendritic polyesteramide polymers, and the dendritic polymers based on 1,3,5-tris-alkanol-substituted cyanuric acid, as toughness-improving addition in epoxy systems cured with anionically curing catalysts, and also to cured epoxy resin made of the curable composition, and to moldings produced therefrom.

Epoxy compounds are used for producing coatings, as adhesive, for producing moldings, and for many other purposes. During the process here, they are generally present in liquid form (as solutions in suitable solvents or as liquid, solvent-free 100% systems). The epoxy compounds are generally low-molecular-weight compounds or linear oligomers. During use they are cured. There are various known curing methods. When epoxy compounds having at least two epoxy groups are used as starting materials, curing can be achieved via a polyaddition reaction (chain extension) with an amino compound having at least two amino functions, or an anhydride compound having at least one anhydride group. The functionality of an amino compound here corresponds to its number of NH bonds. The functionality of a primary amino group is therefore 2, whereas the functionality of a secondary amino group is 1. Amino hardeners suitable for the polyaddition reaction therefore have at least two secondary or at least one primary amino group. Linkage of the amino groups of the amino hardener to the epoxy groups of the epoxy compound forms copolymers, of which the monomer units are formed by the amino hardener and the epoxy compound. Amino hardeners are therefore generally used in a stoichiometric ratio to the epoxy compounds. If by way of example the amino hardener has two primary amino groups, i.e. can couple to up to four epoxy groups, crosslinked structures can be produced. Amino or anhydride compounds with high reactivity are generally added only briefly prior to the desired curing process. These systems are therefore known as two-component (2C) systems.

Catalysts can moreover be used for homo- or copolymerization of the epoxy compounds.

Catalysts that induce homopolymerization are Lewis bases (anionic homopolymerization; anionically curing catalysts) or Lewis acids (cationic homopolymerization; cationically curing catalysts). They bring about the formation of ether bridges between the epoxy compounds. It is assumed that the catalyst reacts with a first epoxy group, with ring-opening, whereupon a reactive hydroxy group is produced, which in turn reacts with another epoxy group to form an ether bridge, the result being a novel reactive hydroxy group. Because of this reaction mechanism, a substoichiometric amount of these catalysts is sufficient for the hardening process. Imidazole is an example of a catalyst which induces anionic homopolymerization of epoxy compounds. Boron trifluoride is an example of a catalyst which initiates cationic homopolymerization. Suitable catalysts should have good miscibility with the epoxy compounds. Latent catalysts are catalysts which induce homopolymerization and which are active only at high temperatures. An advantage of these latent catalysts is that single-component (1C) systems can be used, i.e. the epoxy compounds can comprise the latent catalysts, without any undesired premature curing. The mixtures should have maximum shelf life at room temperature under usual storage conditions, so that they are suitable as storable 1C systems. However, the temperatures required for the curing process during use should not be excessively high, and in particular they should be 200° C. or lower. Relatively low curing temperatures can save energy costs and avoid undesired side reactions. Despite the relatively low curing temperature, impairment of the mechanical properties and performance characteristics of the cured systems should be minimized. It is desirable that these properties (e.g. hardness, flexibility, adhesion, etc.) remain at at least the same good level or indeed are improved.

Imidazolium salts have proven to be latent anionic catalysts with advantageous properties for the curing process (Ricciardi et al., J Polymer Sci Part C (Polymer Letters) (1983) 21:633-638; DE-A 2416408; U.S. Pat. No. 3,635,894; Kowalczyk and Spychaj, Polimery (2003) 48:833-835; Sun et al., Adhesion Sci Techn (2004) 18:109-121; JP 2004-217859; EP 458502; WO 2008/152002; WO 2008/152003; WO 2008/152004; WO 2008/152005; WO 2008/152011). Imidazolium salts which are liquid under standard conditions (ionic liquids) are particularly advantageous for use as hardeners for liquid epoxy compositions.

The use of these latent catalysts as hardeners in epoxy systems can give a combination of an advantageous processing time with curing-process conditions that are easy to operate. Advantages of these epoxy systems are rapid and complete hardening at an elevated temperature and a sufficiently long processing time, for example at room temperature, permitting production of large and complex moldings, and also permitting good penetration of the fibers in the case of composite materials. It would be desirable to have cured epoxy resins which are based on these epoxy systems and which moreover have improved mechanical properties, a particular example being improved toughness.

An object of the invention can therefore be considered to be the provision of additions which are intended for compositions made of epoxy compounds and of anionically curing catalysts for the curing process (in particular imidazolium salt hardener) and which improve the mechanical properties, in particular the toughness, of the cured epoxy resins resulting therefrom.

The present invention therefore provides curable compositions comprising one or more epoxy compounds, one or more anionically curing catalysts for the curing of epoxy compounds, and an addition of one or more dendritic polymers, selected from the group consisting of the dendritic polyester polymers, the dendritic polyesteramide polymers, and the dendritic polymers based on 1,3,5-tris-alkanol-substituted cyanuric acid.

The invention also provides a process for curing the curable composition.

The invention further provides a cured epoxy resin obtainable via the curing of the curable composition of the invention. It is preferable that the cured epoxy resin takes the form of a molding, particularly the form of a composite material, for example with glass fibers or carbon fibers. The invention also provides fibers (e.g. glass fibers or carbon fibers) preimpregnated with the curable composition of the invention (e.g. prepregs).

The invention further provides the use of dendritic polymers selected from the group consisting of the dendritic polyester polymers, the dendritic polyesteramide polymers, and the dendritic polymers based on 1,3,5-tris-alkanol-substituted cyanuric acid, in curable compositions made of epoxy compounds and of anionically curing catalysts for the curing of epoxy compounds to improve the toughness of the cured epoxy resin.

Particular anionically curing catalysts for the curing of epoxy compounds are imidazoles (imidazole and derivatives thereof) and imidazolium salts (salts of imidazolium and of derivatives of imidazolium), preferably imidazolium salts. For the purposes of this invention, “imidazoles” are imidazole and derivatives thereof. For the purposes of this invention, “imidazolium salts” are salts of imidazolium and salts of derivatives of imidazolium. In this context, derivatives are compounds characterized via an imidazole ring or imidazolium ring.

WO 2008/152003, expressly incorporated herein by way of reference (in particular page 3, line 24 to page 8, line 31), describes imidazolium salts which are suitable as latent anionically curing catalyst for the curing process for the curable composition of the invention.

Particularly suitable imidazolium salts as anionically curing catalysts for the curing of epoxy compounds are 1,3-substituted imidazolium salts of the formula I

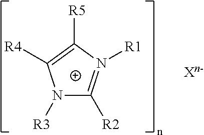

in which
R1 and R3 are mutually independently an organic moiety having from 1 to 20 carbon atoms
R2, R4, and R5 are mutually independently an H atom or an organic moiety having from 1 to 20 carbon atoms, in particular from 1 to 10 carbon atoms, where R4 and R5 can also together form an aliphatic or aromatic ring,
X is an anion, and
n is 1, 2 or 3.

Preference is given to 1,3-substituted imidazolium salts of the formula I in which the anion X has a pK_{B} smaller than 13 (measured at 25° C. and 1 bar in water or dimethyl sulfoxide). Particularly suitable anions X that may be mentioned are systems having one or more carboxylate groups (carboxylates) which have the above pK_{B}, preferably aliphatic monocarboxylates having from 1 to 20 carbon atoms, particularly preferably formate, acetate, propionate, and butyrate. Other suitable anions X having a pK_{B} smaller than 13 are cyanide and cyanate.

Preference is also given to 1,3-substituted imidazolium salts of the formula I in which the anion X has been selected from the group consisting of thiocyanate anion, dicyanamide anion, and anions of an oxo acid of phosphorus.

Preference is further given to 1,3-substituted imidazolium salts of the formula I in which R2 is an H atom.

Particularly preferred imidazolium salts for the curable composition of the invention are 1-ethyl-3-methylimidazolium acetate (EMIM-Ac), 1-ethyl-3-methylimidazolium thiocyanate (EMIM-SCN), 1-ethyl-2,3-dimethylimidazolium acetate, and 1-ethyl-2,3-dimethylimidazolium acetate-acetic acid complex. Very particular preference is given to EMIM-Ac.

Examples of imidazoles (imidazole and derivatives thereof) suitable as anionically curing catalysts for the curing of epoxy compounds are the compounds selected from the group consisting of imidazole, 2-methylimidazole, 2-ethylimidazole, 2-undecylimidazole, 2-heptadecylimidazole, 2-phenylimidazole, 1,2-dimethylimidazole, 2-ethyl-4-methylimidazole, 2-phenyl-4-methylimidazole, 1-benzyl-2-phenylimidazole, 1-benzyl-2-methylimidazole, 1-cyanoethyl-2-methylimidazole, 1-aminoethyl-2-methylimidazole, and 1-aminopropylimidazole.

It is also possible to use other anionically curing catalysts in corresponding fashion, instead of imidazolium salts or imidazoles, for the curing of epoxy compounds.

For the purposes of this invention, anionically curing catalysts for the curing of epoxy compounds are Lewis bases, where these induce anionic homopolymerization of the epoxy compounds. They can bring about the complete curing of the epoxy compound without addition of other hardeners and even in substoichiometric amounts, based on the epoxy compounds. Complete curing is in particular achieved when at least 90% of the epoxy groups of the epoxy compounds have reacted with bridging of the monomers.

The anionically curing catalysts for the curing of epoxy compounds can also be used in combination with additional anhydride hardener. The anionically curing catalysts can initiate and thus accelerate the copolymerization of epoxy compound and anhydride hardener. This invention therefore also provides curable compositions comprising one or more epoxy compounds, one or more anionically curing catalysts for the curing of epoxy compounds, one or more anhydride hardeners, and an addition of one or more dendritic polymers selected from the group consisting of the dendritic polyester polymers, the dendritic polyesteramide polymers, and the dendritic polymers based on 1,3,5-tris-alkanol-substituted cyanuric acid. Suitable anhydride hardeners are cyclic carboxylic anhydrides such as succinic anhydride, maleic anhydride, phthalic anhydride, hexahydrophthalic anhydride, methylbicyclo[2,2,1]hept-5-ene-2,3-dicarboxylic anhydride, or trimellitic anhydride.

Among the dendritic polymers are dendrimers and hyperbranched polymers. Hyperbranched polymers are like dendrimers in featuring a highly branched structure and high functionality. Dendrimers are macromolecules which have molecular uniformity and a highly symmetrical structure. They can be produced by starting from a central molecule and using controlled, stepwise linkage of polyfunctional monomers to previously bonded monomers. With each linkage step here, the number of terminal monomer groups (and therefore of linkages) becomes multiplied by a factor of 2 or more, and the products are monodisperse polymers produced by a generation-based process and having dendritic structures which are ideally spherical, with branches comprising exactly the same number of monomer units. However, a factor that complicates the production of monodisperse dendrimers is that every linkage step requires introduction of, and in turn removal of, protective groups, and intensive purification steps are required before beginning each new stage of growth; dendrimers are therefore usually only produced on a laboratory scale. The generation-based method of production described is necessary in order to produce dendrimeric structures which are completely regular.

In contrast, hyperbranched polymers have both molecular and structural nonuniformity. They are obtained by a non-generation-based production method. Nor is it therefore necessary to isolate and purify intermediates. Hyperbranched polymers can be obtained by simple mixing of the components required for the structure, and reacting these in a “one-pot” reaction. Hyperbranched polymers can have dendrimeric substructures. Alongside this, however, they also have linear polymer chains and unequal polymer branches. Particularly suitable compounds for synthesizing hyperbranched polymers are “ABₓ monomers”. These have two different functional groups A and B in one molecule, and these groups can react with one another intermolecularly to form a linkage. There is only one functional group A per molecule here, while there are two or more functional groups B per molecule. The reaction of said ABₓ monomers with one another produces uncrosslinked polymers having regularly arranged branching points. The chain ends of the polymers have almost exclusively B groups.

Hyperbranched polymers can also be produced by way of the Aₓ+B_{y} synthesis route. Here, Aₓ and B_{y} are two different monomers having the functional groups A and B, and the indices x and y are the number of functional groups per monomer. In the example taken here of Aₓ+B_{y} synthesis, A₂+B₃ synthesis, a difunctional monomer A₂ is reacted with a trifunctional monomer B₃. The initial product is a 1:1 adduct made of A monomers and of B monomers and having an average of one functional group A and two functional groups B, and this can likewise react to give a hyperbranched polymer. Again, the resultant hyperbranched polymers have predominantly B groups as terminal groups.

The degree of branching DB of the dendritic polymers is defined as

$$DB ( \% ) = \frac{T + Z}{T + Z + L} \times 100 ,$$

where T is the average number of terminally bonded monomer units, Z is the average number of monomer units forming branches, and L is the average number of linearly bonded monomer units in the macromolecules of the respective substances.

The degree of branching thus defined distinguishes hyperbranched polymers from dendrimers. Dendrimers are polymers of which the degree of branching DB is from 99 to 100%. A dendrimer therefore has the maximum possible number of branching points, and this can only be achieved via a highly symmetrical structure. For the definition of “degree of branching”, see also Frey et al., Acta Polym. (1997), 48:30.

For the purposes of this invention, therefore, hyperbranched polymers are in essence uncrosslinked macromolecules which have structural nonuniformity. Their structure can be based on a central molecule, by analogy with dendrimers, but with non-uniform chain length of the branches. However, their structure can also be linear, having functional pendant branches, or else they can have linear and branched portions of the molecule. For the definition of dendrimers and of hyperbranched polymers, see also Flory, J. Am. Chem. Soc. (1952), 74:2718 and Frey et al., Chem. Eur. J. (2000), 6:2499. Further information relating to hyperbranched polymers and synthesis thereof can be found by way of example in J.M.S.—Rev. Macromol. Chem. Phys. (1997), C37:555-579 and the references cited therein.

Either dendrimers or hyperbranched polymers can be used as dendritic polymers in the invention. It is preferable to use hyperbranched polymers, where these differ from dendrimers, i.e. where these have both structural and molecular nonuniformity (and therefore do not have uniform molecular weight, but instead have a molecular weight distribution).

For the purposes of the invention, “hyperbranched” means that the degree of branching (DB) is from 10 to 99%, preferably from 25 to 90%, and in particular from 30 to 80%. “Dendrimers” in this context are dendritic polymers having a degree of branching (DB) of from >99 to 100%.

The hyperbranched polymers used in the invention are in essence uncrosslinked. For the purposes of the present invention, “in essence uncrosslinked” or “uncrosslinked” means that the degree of crosslinking is less than 15% by weight, preferably less than 10% by weight, where the degree of crosslinking is determined by way of the insoluble fraction of the polymer. By way of example, the insoluble fraction of the polymer is determined via extraction for 4 hours, in a Soxhlet apparatus, with a solvent identical with that used for the gel permeation chromatography process (GPC), i.e. preferably dimethylacetamide or hexafluoroisopropanol, depending on which solvent is more effective in dissolving the polymer, and weighing of the remaining residue after drying to constant weight.

The weight-average molar mass Mw of the dendritic polymers used in the invention is preferably at least 500 g/mol, e.g. from 500 to 200 000 g/mol, or preferably from 1000 to 100 000 g/mol, in particular from 1000 to 10 000 g/mol.

In one embodiment of the invention, the dendritic polymers are dendritic polyester polymers based on monomers having a carboxylic acid group and two or more alcohol groups. The synthesis of these compounds is described by way of example in WO 93/17060. It is preferable that the monomers have no heteroatoms other than the O atoms of the carboxylic acid groups and of the alcohol groups. It is preferable that the monomer is an aliphatic monocarboxylic acid having from 2 to 20 carbon atoms and two alcohol groups, particularly preferably an aliphatic monocarboxylic acid having from 4 to 20 carbon atoms and two alcohol groups, where different carbon atoms bear the alcohol groups. It is preferable that the alcohol groups of the monomer are chemically equivalent and have identical reactivity. In one variant, said polyester polymers are based on a mono- or polyhydric alcohol as central molecule to which the monomers have been linked by the carboxylic acid group thereof, with formation of an ester bridge. It is preferable that the central molecule is a polyhydric alcohol having from 1 to 20 carbon atoms, e.g. 2,2-dimethylolbutan-1-ol or pentaerythritol, or a derivatives thereof, where alcohol groups thereof have been etherified with diols, such as glycol. The terminal monomer units of the polyester polymers have free alcohol groups (polyester polyols), which can also however have been modified. Examples of these polyester polyols are Boltorn® P500, Boltorn® P1000, and Boltorn® H2004 (from Perstorp Specialty Chemicals AB). By way of example, Boltorn® P500 is based on 2,2-dimethylolpropionic acid as monomer and 2,2-dimethylolbutanol as central molecule.

In one embodiment of the invention, the dendritic polymers are polyesteramide polymers based on N,N-disubstituted carboxamides as monomer, having a free carboxylic acid group and two or more alcohol groups. These monomers can be produced by way of example via equimolar reaction of a carboxylic anhydride with a secondary amine, the moieties of which have a total of at least two alcohol groups. The moieties of the amine are preferably aliphatic alkanol moieties preferably having from 1 to 20, in particular from 2 to 10, carbon atoms. It is preferable that the two moieties of the secondary amine are identical. An example of a suitable secondary amine is diisopropanolamine (DIPA). An example of a suitable carboxylic anhydride is succinic anhydride, maleic anhydride, phthalic anhydride (PA), or hexahydrophthalic anhydride (HHPA). It is also possible to use a mixture of suitable secondary amines and of carboxylic anhydrides to produce the monomers. The polyesterification of the monomers to give the polyesteramide polymer can be achieved catalytically or non-catalytically. The terminal monomer units of the polyesteramide polymers have free alcohol groups (polyesteramide polyol), which can however have been modified. Examples of these polyesteramide polymers are Hybrane® polymers (from Royal DSM N.V.). The synthesis of these compounds is described by way of example in US 20020019509A.

In another embodiment of the invention, the dendritic polymers are polymers based on 1,3,5-tris-alkanol-substituted cyanuric acid as monomer. In the case of these dendritic polymers, the triol monomers have been polycondensed with elimination of water and formation of ether bridges. An example of a suitable triol monomer is 1,3,5-tris(2-hydroxyethyl)cyanuric acid (THIC), the oligomerization of which is described in WO 2006/084488. The terminal monomer units of the dendritic polymers based on 1,3,5-tris-alkanol-substituted cyanuric acid have free alcohol groups, which can however have been modified.

For the purposes of the invention, alkanols are alkyl moieties which have at least one free alcohol group and from 1 to 20 carbon atoms. They can be linear, branched, or cyclic. It is preferable that they have no heteroatoms other than the oxygen atoms of the alcohol group(s).

The dendritic polymers used in the invention are preferably polyols having terminal alcohol groups. For the purposes of this invention, terminal groups are free functional groups of the terminal monomers of the dendritic polymer. It is preferable that these polyols have an average of from 3 to 1000 alcohol groups, particularly from 5 to 500 alcohol groups, very particularly from 6 to 50 alcohol groups. Their OH number is usually from 100 to 1000 mg KOH/g or higher, preferably from 100 to 800 mg KOH/g, particularly preferably from 120 to 700 mg KOH/g. The OH number is determined to DIN 53240, part 2.

In an alternative embodiment, the terminal alcohol groups of the dendritic polymers used in the invention have been modified with reagents which have a reactive group suitable for coupling with the terminal alcohol groups. By way of example, the reactive group can be an alcohol group which forms ether bridges with the terminal alcohol groups of the polyol, or can be a carboxylic acid group, or can be an activated carboxylic acid group (for example acyl chloride or anhydride), which forms ester bridges with the terminal alcohol groups of the polyol. In this case it is preferable that at least 10% of the terminal alcohol groups have been modified, particularly at least 40%, very particularly at least 70%. The modifying reagent can have further functional groups (e.g. carboxylic acid groups), so that said groups then represent the terminal groups of the modified dendritic polymer. The nature of the reagent can also be such that, alongside the reactive group, it has only one aliphatic or aromatic moiety without other heteroatoms. The aliphatic or aromatic moiety is preferably a moiety made of from 1 to 25 carbon atoms. By way of example, this type of modifying reagent is a fatty acid, acetic acid, or benzoic acid, or an activated derivative thereof. One example of a hyperbranched polymer modified in this way is Boltorn® U3000 (from Perstorp Specialty Chemicals AB).

The addition of hyperbranched polymers has been reported in various contexts for modifying mechanical properties for epoxy systems, the curing of which is provided via amino hardeners or via UV radiation (Ratna et al., J Mater Sci (2003) 38:147-154; Ratna et al., Polymer (2001) 42:8833-8839; Ratna et al., Polym. Eng Sci (2001) 41:1815-1822; Sangermano et al., Polym Int (2005) 54:917-921; Boogh et al., Proceedings ICCM-12 Conference, Paris, France (1999); Cicala et al., Poly Eng Sci (2009) 49:577-584). However, the systems studied in the work reported above are based on curing-process reaction mechanisms other than those used in the epoxy systems of the invention with anionically curing catalysts for the curing of the epoxy compounds.

Preferred compositions are composed of at least 30% by weight, preferably at least 50% by weight, very particularly preferably at least 70% by weight, of epoxy compounds (ignoring solvents optionally used concomitantly).

The content of the anionically curing catalyst for the curing of the epoxy compound is preferably from 0.01 to 10 parts by weight for every 100 parts by weight of epoxy compound, particularly preferably being at least 0.1 part by weight, in particular at least 0.5 part by weight, and very particularly preferably at least 1 part by weight, for every 100 parts by weight of epoxy compound. It is preferable that the content is not higher than 8 parts by weight, in particular not higher than 6 parts by weight, for every 100 parts by weight of epoxy compound, and the content can by way of example in particular be from 1 to 6 parts by weight, or from 3 to 6 parts by weight, for every 100 parts by weight of epoxy compound. This particularly applies when the imidazolium salt of the formula I is used as anionically curing catalyst for the epoxy compound.

The content of the dendritic polymer is preferably from 0.1 to 20 parts by weight for every 100 parts by weight of epoxy compound, particularly preferably being at least 0.5 part by weight, and very particularly preferably at least 1 part by weight, for every 100 parts by weight of epoxy compound. The content is preferably not higher than 15 parts by weight, in particular not higher than 12 parts by weight, for every 100 parts by weight of epoxy compound.

Epoxy compounds of this invention have from 2 to 10, preferably from 2 to 6, very particularly preferably from 2 to 4, and in particular 2, epoxy groups. The epoxy groups are in particular the glycidyl ether groups produced during the reaction of alcohol groups with epichlorohydrin. The epoxy compounds can be low-molecular-weight compounds, where these generally have an average molar mass (Mw) smaller than 1000 g/mol, or relatively high-molecular-weight compounds (oligomers or polymers). The degree of oligomerization of these oligomeric or polymeric epoxy compounds is preferably from 2 to 25, particularly preferably from 2 to 10, monomer units. The compounds can be aliphatic, or cycloaliphatic, or compounds having aromatic groups. In particular, the epoxy compounds are compounds having two aromatic or aliphatic 6-membered rings, or oligomers of these. Compounds of industrial importance are epoxy compounds which are obtainable via reaction of epichlorohydrin with compounds which have at least two reactive H atoms, in particular with polyols. Particularly important compounds are epoxy compounds which are obtainable via reaction of epichlorohydrin with compounds which comprise at least two, preferably two, hydroxy groups, and which comprise two aromatic or aliphatic 6-membered rings. Particular examples that may be mentioned of compounds of this type are bisphenol A and bisphenol F, and also hydrogenated bisphenol A and bisphenol F. Epoxy compounds of this invention usually used are bisphenol A diglycidyl ethers (DGEBA). It is also possible to use reaction products of epichlorohydrin with other phenols, e.g. with cresols or with phenol-aldehyde adducts, e.g. with phenol-formaldehyde resins, in particular with novolacs. Other suitable epoxy compounds are those which do not derive from epichlorohydrin. Examples of those that can be used are epoxy compounds which obtain the epoxy groups via reaction with glycidyl (meth)acrylate.

The curable composition of the invention can comprise further constituents in addition to the epoxy compound, the anionically curing catalyst, and the dendritic polymer selected from the group consisting of the dendritic polyester polymers, the dendritic polyesteramide polymers, and the dendritic polymers based on 1,3,5-tris-alkanol-substituted cyanuric acid. Examples of these additional constituents are phenolic resins, anhydride hardeners, fillers, or pigments. The composition of the invention can also comprise solvents. Organic solvents can optionally be used in order to adjust to desired viscosities. It is preferable that the composition comprises at most subordinate amounts of solvents, for example less than 5 parts by weight for every 100 parts by weight of epoxy compound.

The curable composition of the invention is suitable for 1 C systems or else as storable component for 2 C systems. In the case of 2 C systems, the components are brought into contact with one another only briefly prior to use, and the resultant mixture is then not stable in storage because the crosslinking reaction or curing process begins and leads to a viscosity rise. 1 C systems already comprise all of the necessary constituents, and are storage-stable.

The composition using latent anionically curing catalysts for the curing of the epoxy compound is preferably liquid at processing temperatures of from 10 to 100° C., particularly preferably from 20 to 40° C. The increase in viscosity of the entire composition at temperatures up to 50° C. over a period of 10 hours, in particular of 100 hours (from addition of the latent catalyst) is smaller than 20%, particularly preferably smaller than 10%, very particularly preferably smaller than 5%, in particular smaller than 2%, based on the viscosity of the composition without the latent catalyst at 21° C. and 1 bar.

The curing process can take place at standard pressure and at temperatures below 250° C., in particular at temperatures below 200° C., preferably at temperatures below 175° C., in particular in the temperature range from 40 to 175° C. After the curing process, the material can optionally also be heated. The preferred temperature range for the heating process is from 10° C. below the T_{g} of the material to 60° C. above the T_{g} of the material. Preference is given to heating for at least one hour.

The compositions of the invention are suitable as coating compositions or as impregnating compositions, or as adhesive, for the production of moldings and of composite materials, or as casting compositions for embedding, binding, or reinforcement of moldings. An example that may be mentioned of a coating composition is a lacquer. In particular, the compositions of the invention can be used to obtain scratch-resistant protective lacquers on any desired substrates, e.g. made of metal, plastic, or of timber materials. The compositions are also suitable as insulating coatings in electronic applications, e.g. as insulating coating for wires and cables. Mention may also be made of the use for the production of photoresists. They are also particularly suitable as repair lacquer, e.g. for uses including the renovation of pipes without dismantling of the pipes (cure in place pipe (CIPP) rehabilitation). They are also suitable for the sealing of floorcoverings.

In composite materials (composites), there are various materials bonded to one another, examples being plastics and reinforcement materials (e.g. glass fibers or carbon fibers).

Production processes that may be mentioned for composite materials are the curing of preimpregnated fibers or fiber textiles (e.g. prepregs) after storage, and also extrusion, pultrusion, winding, and resin transfer molding (RTM), and resin infusion technologies (RI).

The compositions are suitable by way of example for the production of preimpregnated fibers, e.g. prepregs, and for the further processing of these to give composite materials. In particular, the fibers can be saturated with the composition of the invention and then cured at a relatively high temperature. No, or only slight, curing occurs during the saturation process and any optional subsequent storage.

Addition, in the invention, of dendritic polymers selected from the group consisting of the dendritic polyester polymers, the dendritic polyesteramide polymers, and dendritic polymers based on 1,3,5-tris-alkanol-substituted cyanuric acid when epoxy compounds are used with anionically curing catalysts, for the curing of the epoxy compound, in particular with imidazolium salts as latent catalysts for the curing process, improves the toughness of the cured epoxy resin that can be produced therefrom, when comparison is made with corresponding compositions without said addition. In particular, there is an improvement in fracture toughness (K_{IC}) of the cured epoxy resins. There is only a slight reduction in the glass transition temperature (T_{g}) here. Addition, in the invention, of dendritic polymers selected from the group consisting of the dendritic polyester polymers, the dendritic polyesteramide polymers, and dendritic polymers based on 1,3,5-tris-alkanol-substituted cyanuric acid causes no, or only slight, reduction of the modulus of elasticity. Nor does addition, in the invention, of said dendritic polymers in essence have any adverse effect on latency or on the process (shelf life at room temperature, curing-onset temperature, completeness of the curing process) for the anionically induced curing process. A molding with properties thus improved is of particular interest for components, in particular composite materials, which are subject to stringent mechanical requirements.

Fracture toughness K_{IC} is a measure of the resistance of a material to onset of crack propagation. It can be determined to the standard ISO 15386.

The modulus of elasticity is a measure of the resistance exerted by a material to deformation.

Materials with relatively high modulus of elasticity permit the production of components and materials with relatively high stiffness for identical component geometry. The modulus can be determined by the method of Saxena and Hudak, Int J Fracture (1978) 14(5), or to the standards DIN EN ISO 527, DIN EN 20527, DIN 53455/53457, DIN EN 61, or ASTM D638 (tensile test), or to the standards DIN EN ISO 178, DIN EN 20178, DIN 53452/53457, DIN EN 63, or ASTM D790 (flexural test).

The glass transition temperature T_{g} is the temperature at which a plastic begins to soften. It can be determined by means of dynamic differential calorimetry (DSC, Differential Scanning calorimetry) to the standard DIN 53765. It can also be determined by means of dynamic mechanical analysis (DMA). Here, a rectangular test specimen is subjected to torsional stress (DIN EN ISO 6721), using an induced frequency and prescribed deformation, the temperature is raised at a defined rate of increase, and storage modulus and loss modulus are recorded at fixed intervals. The former modulus represents the stiffness of a viscoelastic material. The latter modulus is proportional to the energy dissipated within the material. The phase shift between the dynamic stress and the dynamic deformation is characterized by the phase angle δ. The glass transition temperature can be determined by various methods, e.g. as maximum of the tan δ curve, as maximum of the loss modulus, or by means of a method using tangents on the storage modulus.

The non-limiting examples below are now used for further explanation of the invention.

### EXAMPLE 1

Effect, on mechanical properties of imidazolium-salt-cured epoxy resins, of dendritic polymers selected from the group consisting of the dendritic polyester polymers, the dendritic polyesteramide polymers, and the dendritic polymers based on 1,3,5-tris-alkanol-substituted cyanuric acid

In each case, 90 g of an epoxy resin of bisphenol A type (DGEBA, Epilox A 18-00 from LEUNA-Harze GmbH) and 5 g of 1-ethyl-3-methylimidazolium acetate (EMIM-Ac) were mixed with an addition of 10 g of a dendritic polymer. The dendritic polymers used as addition were Hybrane® 93 (from Royal DSM N.V.), Boltorn® P500 (from Perstorp Specialty Chemicals AB; dried at 110° C. in vacuo prior to use), Boltorn® P1000 (from Perstorp Specialty Chemicals AB), Boltorn® H2004 (from Perstorp Specialty Chemicals AB), Boltorn® U3000 (from Perstorp Specialty Chemicals AB), and oligomeric 1,3,5-tris-(2-hydroxyethyl)cyanuric acid (polyTHIC, produced as in WO 2006/084488, example 1). The reference used comprised a corresponding mixture without addition of any dendritic polymer, but instead with a total of 100 g of DGEBA. The resultant curable compositions were cured at 110° C. for 30 min, and then 160° C. for 3 h.

Resin-only sheets were produced with graduated thickness by means of a casting mold made of aluminum. In order to ensure reliable demolding, the mold halves, and also the seal, were treated with release agent. In order to achieve a good mixing result, epoxy compound and addition were temperature-controlled during the mixing process, homogenized at about 750 revolutions/min, and then degassed. After introducing the weighed amount of the anionically curing catalyst, the mixture was mixed in a vacuum mixer and charged to the preheated mold. The hardening cycle followed (isothermally) in a convection oven. After cooling, the resin-only sheet was removed. The test specimens were extracted by sawing, using a diamond saw blade in a table-mounted circular saw. The notch in the CT specimens was introduced by an HSS saw blade. The drilled holes were introduced on a pedestal drilling machine. For the static fracture toughness tests, a razor blade was used to produce incipient cracks in the CT test specimens with width w 33 mm.

Glass transition temperature Tg was determined by dynamic mechanical analysis (DMA). Here, a rectangular test specimen is subjected to torsional stress (DIN EN ISO 6721), using an induced frequency and prescribed deformation, the temperature is raised at a defined rate of increase, and storage modulus and loss modulus are recorded at fixed intervals. The former modulus represents the stiffness of a viscoelastic material. The latter modulus is proportional to the energy dissipated within the material. The phase shift between the dynamic stress and the dynamic deformation is characterized by the phase angle [symbol] . Glass transition temperature Tg was determined as maximum of the tan [symbol] curve.

To determined static fracture toughness KIc, in each case five compact tension (CT) test specimens were tested on a Zwick universal testing machine. The test velocity is 10 mm/min at a temperature of 23° C. with a relative humidity of 50%. The calculation is made to ISO 15386. Modulus of elasticity was calculated as in Saxena and Hudak, IntJ Fracture (1978),14(5).

Table 1 collates the results of the tests.

TABLE 1
Mechanical properties of imidazolium-salt-(EMIM-Ac-)cured epoxy resins
with and without addition of dendritic polymers

| | | | Modulus of elasticity |
|---|---|---|---|
| Addition | T_{g} (° C.) | K_{IC} (MPam^{1/2}) | (MPa) |
| — | 167 | 0.42 | 2964 |
| Hybrane ® 93 | 135 | 0.46 | 2647 |
| Boltorn ® P500 | 110 | 0.72 | 2723 |
| Boltorn ® P1000 | 117 | 0.66 | 2976 |
| Boltorn ® H2004 | 142 | 0.61 | 2630 |
| Boltorn ® U3000 | 127 | 0.52 | 2250 |
| PolyTHIC | 150 | 0.51 | 2680 |

1. A curable composition, comprising one or more epoxy compounds, one or more anionically curing catalysts for the curing of epoxy compounds, and an addition of one or more dendritic polymers, selected from the group consisting of the dendritic polyester polymers, the dendritic polyesteramide polymers, and the dendritic polymers based on 1,3,5-tris-alkanol-substituted cyanuric acid.

2. The curable composition according to claim 1, where the anionically curing catalyst is an imidazolium salt.

3. The curable composition according to claim 2, where the imidazolium salt is a 1,3-substituted imidazolium salt of the formula I 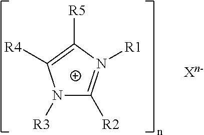
in which
R1 and R3 are mutually independently an organic moiety having from 1 to 20 carbon atoms
R2, R4, and R5 are mutually independently an H atom or an organic moiety having from 1 to 20 carbon atoms, in particular from 1 to 10 carbon atoms, where R4 and R5 can also together form an aliphatic or aromatic ring,
X is an anion, and
n is 1, 2 or 3.

4. The curable composition according to claim 3, where the anion X has been selected from the group consisting of aliphatic monocarboxylate anions having from 1 to 20 carbon atoms, cyanide anion, cyanate anion, thiocyanate anion, dicyanamide anion, and anions of an oxo acid of phosphorus.

5. The curable composition according to claim 1, where the anionically curing catalyst is an imidazole compound selected from the group consisting of imidazole, 2-methylimidazole, 2-ethylimidazole, 2-undecylimidazole, 2-heptadecylimidazole, 2-phenylimidazole, 1,2-dimethylimidazole, 2-ethyl-4-methylimidazole, 2-phenyl-4-methylimidazole, 1-benzyl-2-phenylimidazole, 1-benzyl-2-methylimidazole, 1-cyanoethyl-2-methylimidazole, 1-aminoethyl-2-methylimidazole, and 1-aminopropylimidazole.

6. The curable composition according to any of claims 1 to 5, where the dendritic polymer is a dendritic polyester polymer.

7. The curable composition according to claim 6, where the dendritic polyester polymer is a polyol having terminal alcohol groups.

8. A process for producing cured epoxy resin, which comprises curing the curable composition according to any of claims 1 to 7.

9. The process according to claim 8, where the curing takes place at a temperature of from 40 to 175° C.

10. A cured epoxy resin that can be produced via curing the curable composition according to any of claims 1 to 7.

11. A molding made of the cured epoxy resin according to claim 10.

12. A composite material comprising glass fibers or carbon fibers and the cured epoxy resin according to claim 10.

13. An assembly of fibers preimpregnated with the curable composition according to any of claims 1 to 7.

14. The use of dendritic polymers selected from the group consisting of the dendritic polyester polymers, the dendritic polyesteramide polymers, and the dendritic polymers based on 1,3,5-tris-alkanol-substituted cyanuric acid, in curable compositions made of epoxy compounds and of anionically curing catalysts for the curing of epoxy compounds to improve the toughness of the cured epoxy resin.
